(19) United States
(12) Patent Application Publication
(10) Pub. No.: US 2026/0300903 A1
(43) Pub. Date: Oct. 1, 2026

(54) INFORMATION PROCESSING SYSTEM, INFORMATION PROCESSING METHOD, AND NON-TRANSITORY COMPUTER READABLE MEDIUM

(71) Applicant: Hitachi, Ltd., Tokyo (JP)

(72) Inventors: Amit KUMAR, Tokyo (JP); Qi XIU, Tokyo (JP)

(21) Appl. No.: 19/542,485

(22) Filed: Feb. 17, 2026

(30) Foreign Application Priority Data
Mar. 28, 2025 (JP) 2025-055568

(51) Int. Cl. G06Q 10/083; G06F 16/953

(52) U.S. Cl. CPC G06Q 10/0838; G06F 16/953

(57) ABSTRACT

In an information processing system, a storage apparatus stores a bill of lading including information of a different code for each material that is either a component or a raw material of a product, and a description of the product, and chemical substance information relating to chemical substances contained in the raw material; a memory stores a program; and a processor executes processing according to the program. The processor classifies either as a component or a raw material a material in each tier from the product belonging to a top tier to the raw material belonging to a bottom tier of the supply chain, based on the code information; and the processor links a material belonging to a higher tier and a material belonging to a lower tier for each pair of adjacent higher and lower tiers, based on the product description and the chemical substance information.

### CROSS-REFERENCE TO RELATED APPLICATIONS

This application is based upon and claims the benefit of priority from Japanese Patent Application No. 2025-055568, filed in Japan Patent Office on Mar. 28, 2025, the contents of which are hereby incorporated by reference.

### BACKGROUND

The present disclosure relates to a technique for managing a supply chain that represents a continuous flow from raw material procurement to final product sales.

A global supply chain is embodied in a complex international network in which the supply chain spans across multiple enterprises and multiple countries. The supply chain dependent on a global network is vulnerable during times of crisis, such as a pandemic or natural disaster, or when there is an imbalance of supply and demand. Two specific cases are cited as examples. The first is the shortage of automobile semiconductor chips triggered by the COVID-19 (Coronavirus disease 2019) pandemic. The production of automobile semiconductor chips was disrupted by the COVID-19 pandemic, and this also caused a surge in demand for electronic equipment such as tablet terminals. This resulted in a global shortage of a variety of semiconductor chips. The second is the shortage of resin caused by an imbalance in supply chains that occurred in recent years.

Material procurement personnel of each enterprise have to understand the flow of materials in their products’ supply chain in order to ensure smooth operations of their products’ supply chain even during the above-mentioned crises or imbalances between supply and demand. Many of the enterprises engaging in manufacture keep a wide range of records with respect to the products. These records may be, for example, records of production and shipment of their products, procurement records of components that are constituent elements of the products, and information on raw materials that are constituent elements of the components. It is conceivable that procurement personnel can ascertain the overall supply chain on the basis of these records. However, while information about the components may be recorded in detail in the procurement records, information about the raw materials may not always be. This is because the manufacturing enterprises of components are responsible for procurement of raw materials, which belong to the bottom tier of hierarchy and are at an even lower level than the components which are in the intermediate tier below products. It is difficult for procurement personnel to grasp the end-to-end flow of all materials in a supply chain.

Recorded data such as production and shipment of components and raw materials could be available if the respective suppliers of components and raw materials in the intermediate and bottom tiers were to disclose their recorded data. However, disclosure of such recorded data means that the shipment status of material and buyer information will be known among many enterprises. Therefore, suppliers in the intermediate and bottom tiers generally do not share their recorded data with each other. It is difficult for procurement personnel to organize the flow in the supply chain of their products using only their own fragmented information.

U.S. Patent No. 10102488 discloses a system that receives planning data from many entities included in a value chain and automatically generates a plan according to the planning data. When the system detects a problem in the plan, as disclosed in U.S. Patent No. 10102488, it notifies the relevant entity of the problem, receives instructions regarding how the problem is to be resolved, and updates the planning data on the basis of the feedback.

In an online article "Construction of Enterprise-Level Global Supply Chain Database" by Yuya Katafuchi and four others published on Nov. 27, 2023 in Research Square (accessed on Jan. 16, 2025) on the internet <URL: https://doi.org/10.21203/rs.3.rs-3651986/v1> propose the construction of an enterprise-level multi-regional input-output (EMRIO) table, which is an analytical framework of a global supply chain. The EMRIO table dissects the existing sector-level input-output table into an enterprise-level structure including 47 countries, 8,861 sectors, 9,246 enterprises, 20,098 segments, and 76,622 subsegments.

### SUMMARY

With the system disclosed in U.S. Patent No. 10102488, smooth communications between the entities that are not directly communicating, such as suppliers in the bottom tier, can hardly be achieved. The approach disclosed in the online article "Construction of Enterprise-Level Global Supply Chain Database" dissects the sector level data into enterprise level data, dealing with the transactions between the top tier to which products belong and intermediate tiers to which components belong. However, the data does not ascertain the flow of materials into the bottom tier where raw materials belong. It is difficult to visualize the flow of materials in the supply chain.

An object included in the present disclosure is to provide an information processing system, an information processing method, and a non-transitory computer readable medium that visualize a supply chain from raw materials to final products.

The information processing system according to one aspect of the present disclosure is an information processing system managing a supply chain, which represents a continuous flow from raw material procurement to product sales, the system including: a storage apparatus configured to store a bill of lading including information of a different code for each material that is either a component or a raw material of a product, and a description of the product, and chemical substance information relating to chemical substances contained in the raw material; a memory configured to store a program; and a processor configured to execute processing according to the program. The processor is configured to execute the program to: classify either as a component or a raw material a material in each tier from the product belonging to a top tier to the raw material belonging to a bottom tier of the supply chain, based on the code information; link a material belonging to a higher tier and a material belonging to a lower tier for each pair of adjacent higher and lower tiers, based on the product description and the chemical substance information; and display a material flow showing a continuous flow from the product belonging to the top tier to the raw material belonging to the bottom tier.

According to one aspect of the present disclosure, the materials in adjacent higher and lower tiers are linked to each other, from the product belonging to the top tier to the raw material belonging to the bottom tier, and a material flow showing a continuous flow from the product to the raw material is displayed, thereby visualizing the supply chain.

### BRIEF DESCRIPTION OF THE DRAWINGS

FIG. 1 is a block diagram illustrating a configuration example of an information processing system according to an embodiment;

FIG. 2 is a diagram illustrating an example of BOL data stored in a storage apparatus shown in FIG. 1;

FIG. 3 is a diagram for explaining an example of public information stored in the storage apparatus shown in FIG. 1;

FIG. 4 is a diagram illustrating an example of chemical substance information stored in the storage apparatus shown in FIG. 1;

FIG. 5 is a diagram illustrating an example of TTB data stored in a storage section of the server shown in FIG. 1;

FIG. 6 is a diagram illustrating an example of BTB data stored in the storage section of the server shown in FIG. 1;

FIG. 7 is a diagram illustrating an example of target product’s real data stored in the storage section of the server shown in FIG. 1;

FIG. 8 is a diagram illustrating an example of a hardware configuration of the server shown in FIG. 1;

FIG. 9 is a flowchart showing an operation procedure of the information processing system according the embodiment;

FIG. 10 is a flowchart showing the procedure of generating a positive link model at step S103 shown in FIG. 9;

FIG. 11 is a flowchart showing the procedure of generating a negative link model at step S103 shown in FIG. 9;

FIG. 12 is a flowchart showing the procedure of a specific example of processing at step S104 shown in FIG. 9;

FIG. 13 is a flowchart showing the procedure of a specific example of processing at step S108 shown in FIG. 9;

FIG. 14 is a flowchart showing the procedure of a specific example of processing at steps S104 to S107 shown in FIG. 9;

FIG. 15 is a flowchart showing the procedure of a specific example of processing at steps S104 to S107 shown in FIG. 9;

FIG. 16 is a flowchart showing the procedure of a specific example of processing at step S106 shown in FIG. 9 and step S416 shown in FIG. 15;

FIG. 17 is a diagram illustrating an example of a material flow generated by the information processing system according to the embodiment;

FIG. 18 is a diagram illustrating an example of GUI provided for users by the information processing system according to the embodiment; and

FIG. 19 is a diagram illustrating an example of a visualized material flow provided for users by the information processing system according to the embodiment.

### DETAILED DESCRIPTION OF THE EMBODIMENT

The information processing system according to this embodiment visualizes a continuous flow in a supply chain, and makes clear the interconnections between the materials in the supply chain. In this embodiment, supply chains are not limited to international or global supply chains but may also be supply chains within more local areas such as countries or regions. A global supply chain is a complex international network of enterprises spanning across multiple countries. In this embodiment, for the convenience of explanation, a continuous flow in the supply chain is divided into several tiers. Specifically, the level to which raw materials such as iron and copper belong is defined as the bottom tier, the level to which final products such as automobiles belong is defined as the top tier, and the level to which multiple groups of components between the top and bottom tiers belong is defined as the intermediate tier. The users of the information processing system of this embodiment are, for example, procurement personnel of an enterprise. An example embodiment of the information processing system is described below.

### Embodiment

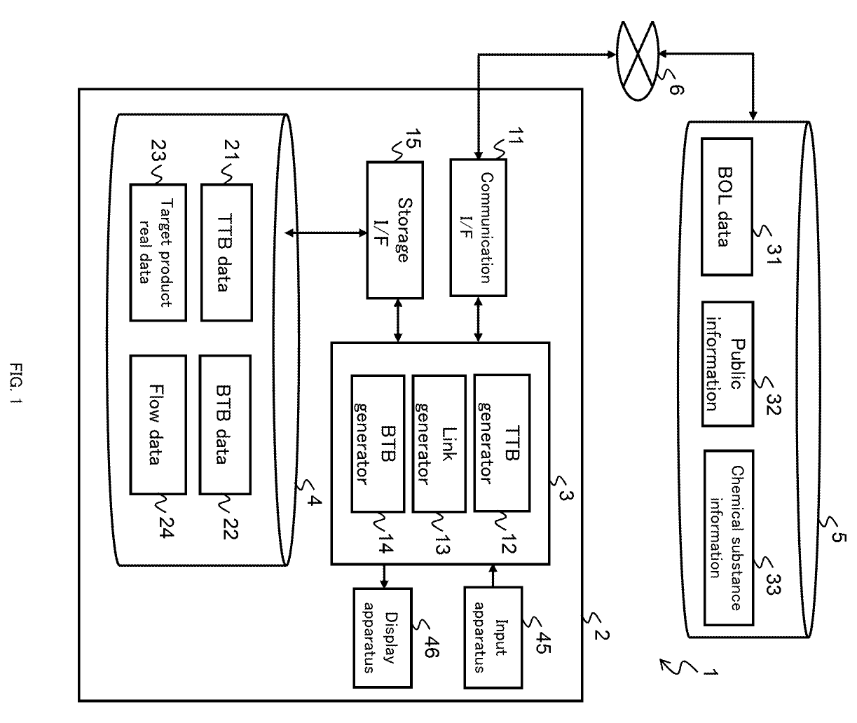

A configuration of the information processing system according to the embodiment is described. FIG. 1 is a block diagram illustrating a configuration example of the information processing system according to the embodiment. The information processing system 1 includes a server 2 and a storage apparatus 5. The storage apparatus 5 stores BOL data 31, public information 32, and chemical substance information 33. A database is configured in the storage apparatus 5 to visualize a material flow. Three major data tables designed for different purposes serve as database tables for visualizing a continuous flow in a supply chain.

The BOL data 31 is a table of a shipping document (Bill of Lading (BOL)) that proves receipt of cargo by an enterprise. The BOL data 31 lists up all the components and raw materials that the enterprise uses to produce its products. The BOL data 31 describes detailed specifications for each of the components and raw materials. For example, the BOL data 31 includes a detailed account of products, components, raw materials, specifications, country names, supplier IDs, buyer IDs, dates, HS codes, periods, prices, invoices, and product descriptions. Components are constituent elements of a product. Raw materials are constituent elements of a component. HS codes include not only component codes but also raw material codes. If there are plural components and/or raw materials, the BOL presents plural HS codes. A supplier ID is an identifier that is unique to each supplier. A buyer ID is an identifier that is unique to each buyer. The BOL data 31 serves as the basic data used for the material flow mapping.

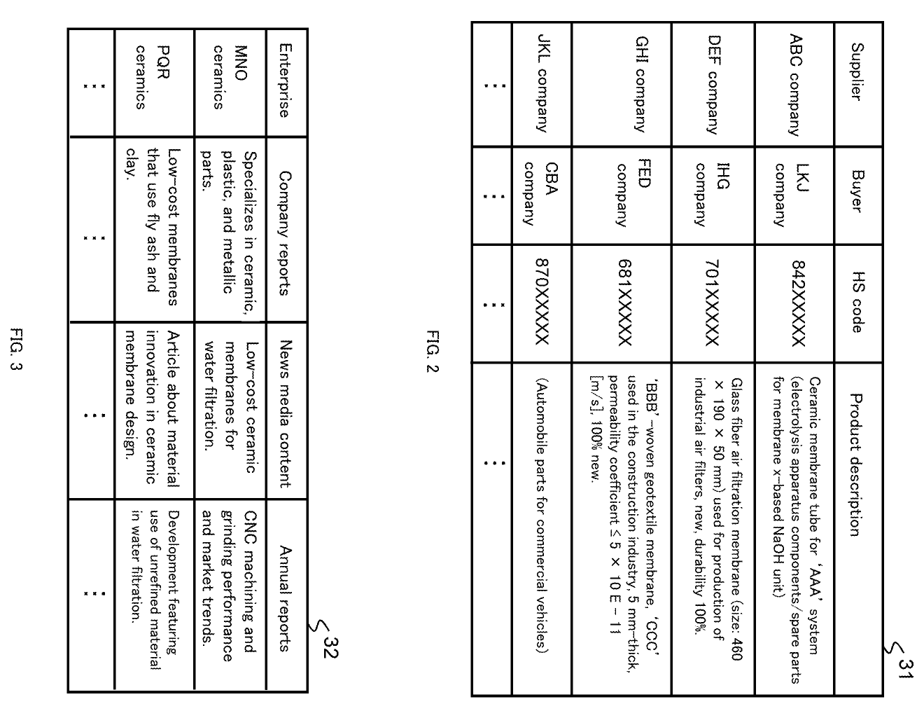

FIG. 2 is a diagram illustrating an example of BOL data stored in the storage apparatus shown in FIG. 1. The BOL data 31 is a table that maps a supplier, a buyer, an HS code, and a product description to one another. The "product" in FIG. 2 represents not just the final "product" in a supply chain, but also a component and a raw material. This is because a component may correspond to the final "product" for an enterprise that supplies the component. Likewise, a raw material may correspond to the final "product" for an enterprise that supplies the raw material. The "supplier" field shows the names of enterprises that supply products. The "buyer" field shows the names of enterprises that buy the products. The HS codes serve as identifiers that specify the target product of trade. Supplier IDs may be used instead of supplier names. Buyer IDs may be used instead of buyer names. Assigning a standardized code to each traded product ensures trade consistency between enterprises. Thus the BOL data 31 is useful when the controller 3 tracks the merchandise flow between suppliers and buyers.

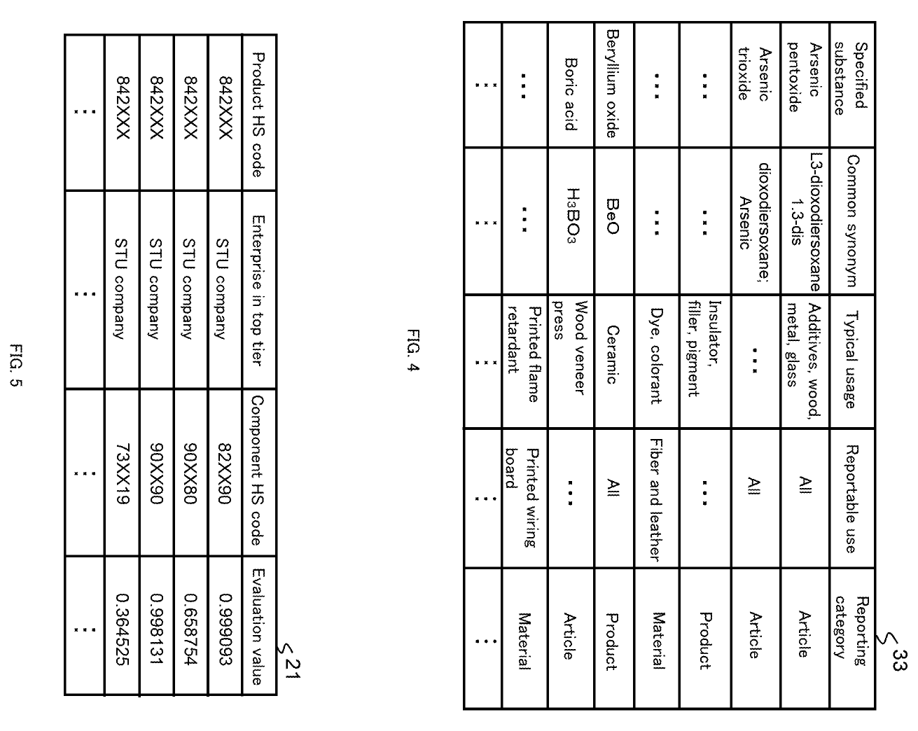

Public information 32 includes the information disclosed by enterprises, company reports, and information published by news media. The public information 32 collects and consolidates the information made public by enterprises, such as reports and articles documenting the use of materials or created for the purpose of monitoring enterprises’ customs. FIG. 3 is a diagram for explaining an example of public information stored in the storage apparatus shown in FIG. 1. The public information 32 maps each enterprise to a company report, news media content, and an annual report. The enterprise field shows a different name for each enterprise. A company report is information that summarizes activities of an enterprise and usage of products provided by the enterprise. News media content is a collection of media coverage relating to an enterprise’s product. An annual report is information that provides the public with business forecasts of an enterprise. All the enterprises involved in the target supply chain monitored by the information processing system 1 are registered in the public information 32.

The chemical substance information 33 is information relating to chemical substances contained in all products, components, and raw materials, such as the data provided by ChemSHERPA (registered trademark), for example. ChemSHERPA (registered trademark) is a leading information-sharing scheme that shares raw materials data. The chemical substance information 33 provides many enterprises with standardized information on how raw materials are used throughout the industry. The chemical substance information 33 serves as the basis when linking a component and a raw material, and a raw material and a chemical substance, based on the material properties, specifications, and/or use of components and raw materials. Chemical substances contained in raw materials are classified into one of several types of chemical substances predetermined in ChemSHERPA (registered trademark). NCS denotes the number of predetermined chemical substance categories, which is, for example, 229.

For example, the chemical substances are explained using a product that is a cable with a connector. The cable with a connector is made up of a cable and a connector coupled to it. The connector contains four chemical substances, for example, which are copper, nickel, diethylhexyl phthalate, and PVC (Polyvinyl chloride). The cable contains four chemical substances, for example, which are copper, diethylhexyl phthalate, PVC, and antimony trioxide.

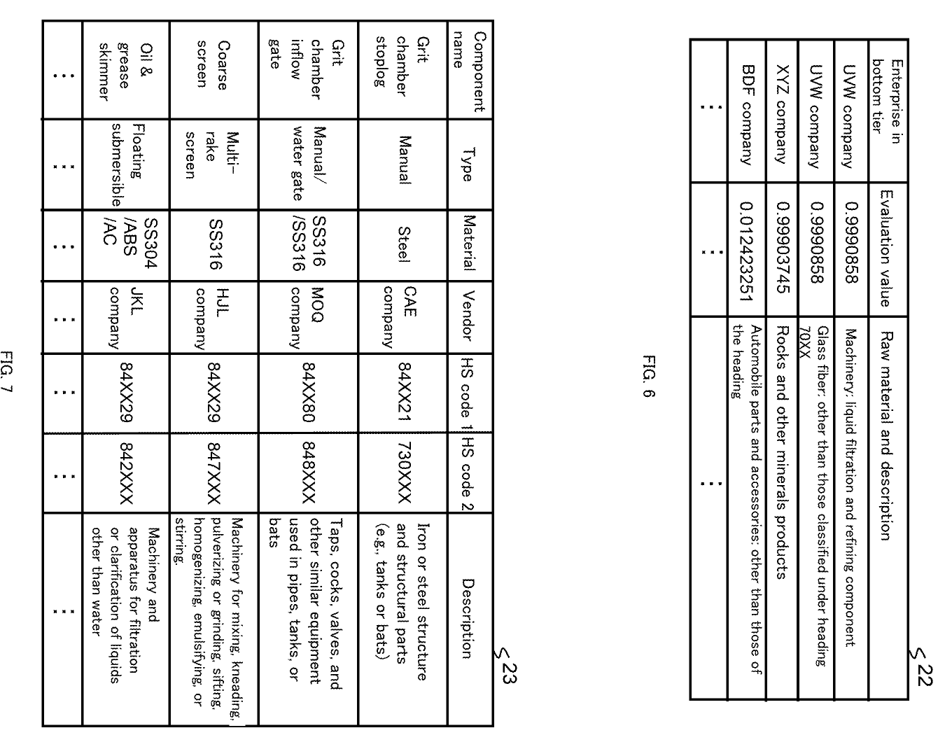

FIG. 4 is a diagram illustrating an example of chemical substance information stored in the storage apparatus shown in FIG. 1. The chemical substance information 33 maps each

specific substance name that identifies a chemical substance to a common synonym, typical usage, a reportable use, and a reporting category. A common synonym is an alternative name for a target substance. Typical usage is a description of common usage of a target substance. The reportable use field specifies the uses for which reporting is required. Reporting category shows the classification levels required for the reporting. The categories include article, material, and product, for example. The chemical substance information 33 provides the information processing system 1 with detailed information on the properties and uses of specific substances, which is useful for users’ compliance and material management. Although not shown in FIG. 4, the table may also show an identifier assigned to each of the specific substances.

These three database tables provide the users a comprehensive overview of a material flow by showing combinations of transaction data, public information, and detailed chemical information. The information processing system 1 of this embodiment enhances supply chain transparency, enabling users to track materials, understand market practices, and effectively manage compliance.

The network 6 is a network that includes the internet, for example. The network 6 functions as the system’s backbone, enabling real-time data exchange and integration. The connectivity is essential for maintaining an accurate and transparent view of the material flow of the entire supply chain.

The configuration of the server 2 shown in FIG. 1 is described. The server 2 is an example of a computer that manages the supply chain. The server 2 includes a controller 3, a storage section 4, an input apparatus 45, and a display apparatus 46. The storage section 4 stores target product real data 23. The storage section 4 stores BOM (Bill of Material) data and flow data 24 generated by the controller 3. The BOM data includes TTB data 21 and BTB data 22. A BOM is referred to as a component table or component structure table. The BOM may include information on a hierarchical structure. The BOM is the basic information that indicates one or more components required for producing a product, and how the one or more components are assembled together. The storage section 4 manages the BOM data and the target product real data 23. For example, when the product is a cable with a connector, its components are a connector and a cable. In this case, the product’s BOM at least includes information that the components are a connector and a cable, and that a connector is coupled to a cable. A supply web database designed to reinforce the supply chain is configured in the storage section 4.

The TTB data 21 is the BOM data of a product that belongs to the top tier. The TTB data 21 includes data associated with the suppliers and makers of the product in the top tier and of the components, which is fundamental to understand the overall supply chain.

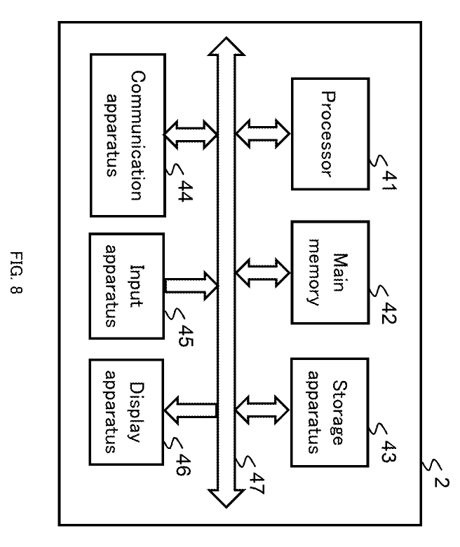

FIG. 5 is a diagram illustrating an example of TTB data stored in the storage section of the server shown in FIG. 1. The TTB data 21 maps a product HS code, a top-tier enterprise, a component HS code, and an evaluation value to one another. The product HS code is a code determined for each item based on the international convention on the harmonized commodity description and coding system. This code is a universal classification number assigned to imported and exported goods. The top-tier enterprise field shows the name of the enterprise that supplies the product. The component HS code shows the HS codes of the components used in the product. The evaluation value shows the indicator values of the metric evaluation for the materials. The TTB data 21 is configured using HS codes to maintain consistency to allow tracking of major materials and enterprises in relation to the top tier of the supply chain. The TTB data 21 may include information of a description for each component.

The BTB data 22 is the BOM data of a raw material that belongs to the bottom tier. The BTB data 22 focuses on subsupplier data and provides the controller 3 with detailed information on the raw materials that belong to the bottom tier.

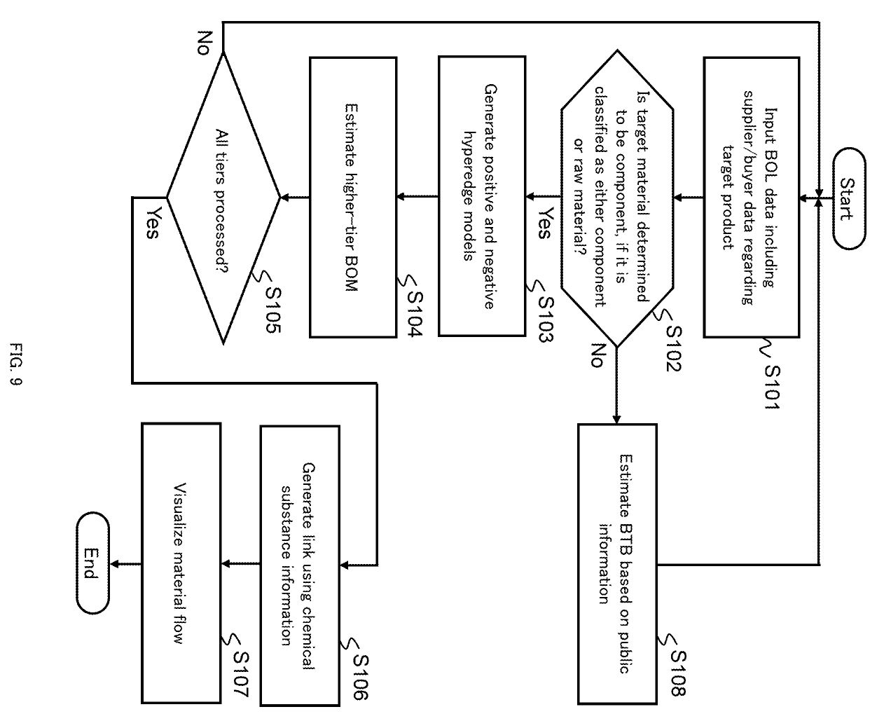

FIG. 6 is a diagram illustrating an example of BTB data stored in the storage section of the server shown in FIG. 1. The BTB data 22 maps a bottom-tier enterprise, an evaluation value, a raw material, and its description to one another. The bottom tier enterprise field shows the names of enterprises that belong to the bottom tier of the supply chain. The bottom-tier enterprises correspond to the suppliers of the raw materials. The evaluation value shows the indicator values of the metric evaluation for the raw materials. The raw material and description field shows the names of raw materials and their descriptions. The BTB data 22 focuses on the raw materials and their uses, and provides the controller 3 with detailed information on the raw materials that belong to the bottom tier and the suppliers of the raw materials.

The target product real data 23 is ground truth data of a target product. The ground truth data is the actual data used in machine learning. The target product real data 23 is stored in the storage section 4 as verified data of the target product to ensure the classification accuracy of machine learning models.

FIG. 7 is a diagram illustrating an example of target product real data stored in the storage section of the server shown in FIG. 1. The target product real data 23 maps each component name to a component type, a component material, a vendor, HS code 1, HS code 2, and a description. The component name serves to identify a specific component from multiple components that form the target product. The type field shows the types of components or mechanisms. The material field shows the material used in the component, or a list of materials if there are two or more. The vendor field shows the names of vendors that supply the components. HS code 1 and HS code 2 are codes for specifying a component through double classification. The description field shows detailed descriptions of the components. The target product real data 23 ensures the accuracy and reliability of data about the components and raw materials used in the product, and is useful for accurate management of the supply chain.

The flow data 24 is data that shows the material flow generated by the controller 3. The flow data 24 is configured with information about links interconnecting the materials of various tiers from the top to the bottom, making the entire supply chain visible.

The supply web database is configured to display an overall view of the flow of materials for each pair of adjacent higher and lower tiers in the supply chain. The supply web database ensures accuracy and transparency by combining the TTB data 21, BTB data 22, and BOL data 31 with the target product real data 23, assisting in more suitable determination and management.

The controller 3 includes a communication I/F (Interface) 11, a TTB generator 12, a link generator 13, a BTB generator 14, and a storage I/F 15. The communication I/F 11 functions as an interface that allows for communication and data exchange between internal components and an external information apparatus. The communication I/F 11 sends and receives data to and from an external information apparatus in accordance with a communication protocol such as an IP (Internet Protocol), for example. The storage I/F 15 writes data into the database configured in the storage section 4, and reads data from the database. The storage I/F 15 facilitates data storage to the database and supports scalability and efficient management of data.

The TTB generator 12 estimates a TTB, which is the BOM of a product that belongs to the top tier of the supply chain, using the BOL data. The TTB shows the component table of the product in the top tier of the supply chain. The BTB generator 14 estimates a BTB, which is the BOM of a raw material that belongs to the bottom tier of the supply chain, using the public information and the chemical substance information 33.

The BTB shows the component table of the raw material in the bottom tier of the supply chain. Sometimes, there are several levels in the intermediate tier between the top and bottom tiers in the supply chain. In the description of this embodiment, the BOMs of the materials that belong to the intermediate tier are estimated by the TTB generator 12.

The link generator 13 has the function of a linking API (Application Programming Interface) that connects materials in the adjacent higher and lower tiers from the top tier to the bottom tier of the supply chain. The link generator 13 displays a material flow showing a continuous flow from the product in the top tier to a raw material in the bottom tier on the display apparatus 46. The link generator 13 ensures seamless data communication with each of the TTB generator 12 and the BTB generator 14.

The databases are configured in the storage section 4 and in the storage apparatus 5 by collecting information, and organizing and managing the collected information. The network 6 provides seamless connection between the storage apparatus 5 and the server 2. The server 2 integrates various types of data and provides the users with a material flow showing a comprehensive overview. The material flow provided by the information processing system 1 allows enterprises to make decisions about material procurement and to optimize the supply chain, which ensures transparency in material sourcing.

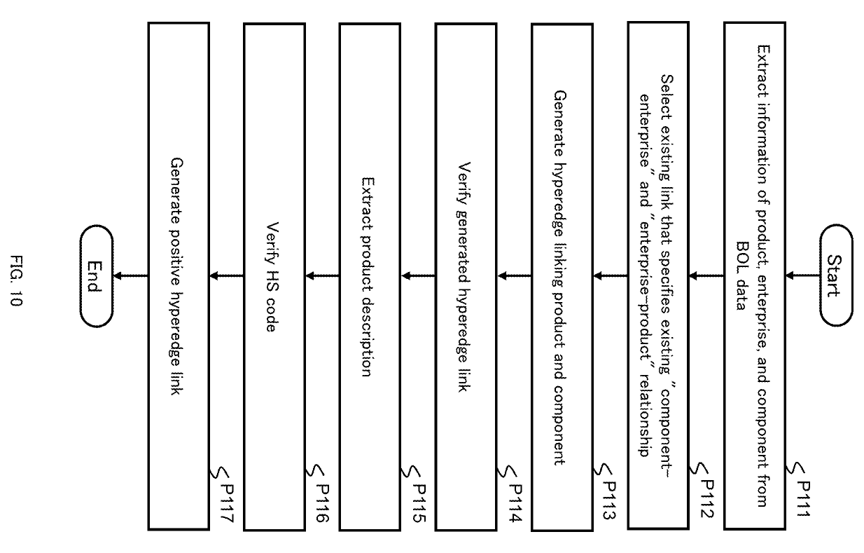

Now, a hardware configuration example of the server 2 is described. FIG. 8 is a diagram illustrating an example of a hardware configuration of the server shown in FIG. 1. The server 2 includes a processor 41, a main memory 42, a storage apparatus 43, a communication apparatus 44, an input apparatus 45, and a display apparatus 46. The processor 41, main memory 42, storage apparatus 43, communication apparatus 44, input apparatus 45, and display apparatus 46 are interconnected to each other via a bus 47 for communication.

The processor 41 is an arithmetic apparatus such as an MPU (Micro Processing Unit) or a CPU (Central Processing Unit), for example. The main memory 42 is, for example, a non-volatile memory such as a flash memory. The main memory 42 stores a program. The processor 41 executing the program stored in the main memory 42 implements the functions of various units such as the TTB generator 12, link generator 13, and BTB generator 14, shown in FIG. 1. Some or all of these functions may be implemented by a dedicated circuit such as an ASIC (Application Specific Integrated Circuit).

The storage apparatus 43 corresponds to the storage section 4 shown in FIG. 1. The storage apparatus 43 is, for example, an HDD (Hard Disk Drive) or an SSD (Solid State Drive). The communication apparatus 44 has the functions of the communication I/F 11 and the storage I/F 15 shown in FIG. 1. The input apparatus 45 is, for example, a mouse, keyboard, or touchscreen. The display apparatus 46 is a display.

The storage apparatus 5 in the block diagram shown in FIG. 1 may not store the chemical substance information 33. For example, the chemical substance information 33 may be stored in an external server (not shown) coupled to the network 6. The storage section 4 may store the data that is stored in the storage apparatus 5. The program executed by the processor 41 need not necessarily be stored in the main memory 42 in advance. The program may be installed from a recording medium (not shown) to the main memory 42.

A plurality of information processing terminals (not shown) operated by users in each of plural enterprises may be coupled to the server 2 via the network 6. The information processing terminals are, for example, a PC (Personal Computer) or a table terminal. The information processing terminal has a configuration similar to the hardware configuration example shown in FIG. 8. Users from many enterprises can couple their information processing terminals to the server 2 and display the material flow provided by the information processing system 1 on the display apparatuses 46 of their information processing terminals.

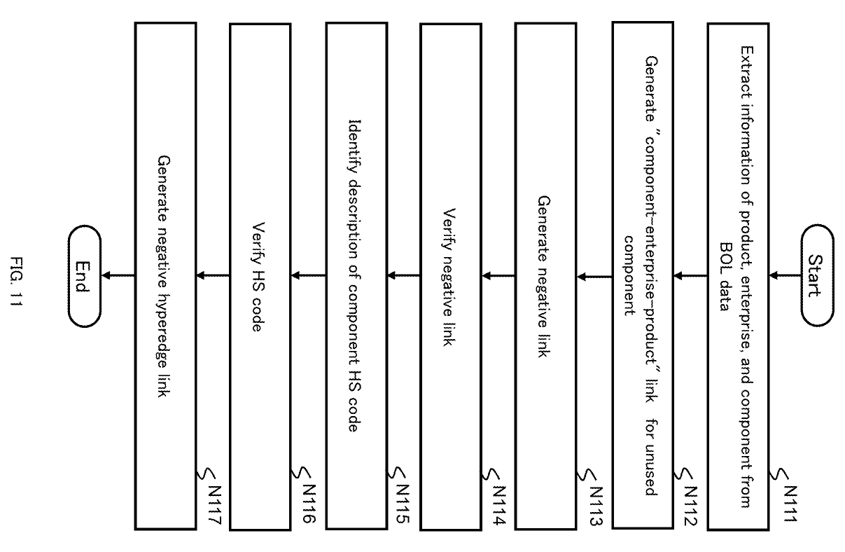

Next, the operation of the information processing system 1 according to the embodiment is described. FIG. 9 is a flowchart showing an operation procedure of the information processing system according the embodiment. The processor 41 executes the program stored in the main memory 42 to operate the system according to the procedure shown in FIG. 9.

At step S101, BOL data including data on suppliers and buyers associated with a target product is input to the processor 41. The data input to the processor 41 here is detailed information including that of suppliers and buyers of the product, based on the BOL data that includes HS codes and product descriptions. The detailed information input here is important when tracking and classifying materials in the supply chain. The target is a product here, since step S101 in FIG. 9 is an early stage of the flow. The target is not limited to the product and may be a component or a material such as a raw material in the processing at step S104 to be described later.

At step S102, the processor 41 determines whether or not the target is classified as a component if it is to be classified as either a component or a raw material. The processor 41 determines whether the target relates to a component or to a raw material. This determination is essential for correct processing of data. As a result of the determination at step S102, which is an early stage of the flow where the target is a product, the product is closer to a component than to a raw material, and as a result, it is determined as a component.

If the result of determination at step S102 indicates that the target is a product or a component, the processor 41 proceeds to estimate a higher-tier BOM. At step S103, the processor 41 generates positive and negative link models when the target is a product. By generating positive and negative link models, the processor 41 determines both positive and negative interactions that represent complex relationships between data spanning multiple tiers. These link models help the processor 41 determine how materials in each tier relate to the materials of other tiers, and how the materials in each tier relate to the product as a whole.

At step S104, the processor 41 estimates a BOM of each higher tier. The processor 41 estimates a BOM for each tier that provides a detailed account of materials required in various levels of production, such as manufacturing levels of a product, and manufacturing levels of a component. When estimating the BOM of the top-tier product, the processor 41 uses the BOL data, as well as the positive and negative link models. This improves the estimation accuracy of the higher-tier flow, so that the estimation accuracy of the entire material flow is improved. At step S105, the processor 41 determines whether or not the processing has been completed for all the tiers. If the result of determination at step S105 indicates that the processing has not been completed for all the tiers, the processor 41 changes the processing target to the next tier, and returns to step S101. If the processing has been completed for all the tiers, the processor 41 proceeds to step S106.

If the result of determination at step S102 indicates that the target is not a component, it means that the target is a raw material. Therefore, the processor 41 proceeds to step S108. At step S108, the processor 41 estimates a BTB based on the public information. The public information is, for example, the information disclosed by enterprises, company reports, or chemical substance information 33. The processor 41 estimates a detailed BOM of the raw material, breaking it down to chemical substances, based on the public information. This enables the forecasting of procuring a raw material that is fundamental to producing the product but has never been purchased before.

At step S106, the processor 41 generates inter-tier links using a linking API based on the chemical substance information 33. More specifically, the processor 41 uses functions of the linking API to generate links between materials, based on the chemical substance information 33, which is the record of information on the specifications and uses corresponding to each chemical substance. This process ensures seamless data connectivity from the top to the bottom tiers, thereby improving the accuracy of material flow mapping.

At step S107, the processor 41 visualizes the material flow, showing a continuous flow from the product in the top tier to a raw material in the bottom tier. This visualization of the entire material flow gives the users a comprehensive understanding of how materials change along the supply chain. The better transparency of the material flow helps the users to track a material more easily. This approach allows the processor 41 to accurately track the movement of materials throughout the entire supply chain, thereby providing visibility. The information processing system 1 distinguishes between components and raw materials and applies advanced data integration techniques to each, thereby enhancing the transparency and efficiency of supply chain management. Consequently, users can more easily monitor the supply chain and make quicker decisions.

At step S102 shown in FIG. 9, the material corresponding to a recorded code in the BOL is classified either as a component or a raw material, and a higher-tier flow and a lower-tier flow that form the material flow are created according to the classification result. A material flow that shows a continuous path of materials from the top-tier product to a raw material via various components is thus formed. This step helps minimize the generation of an erroneous material flow in which a raw material that belongs to the bottom tier is placed between the top tier and the intermediate tier.

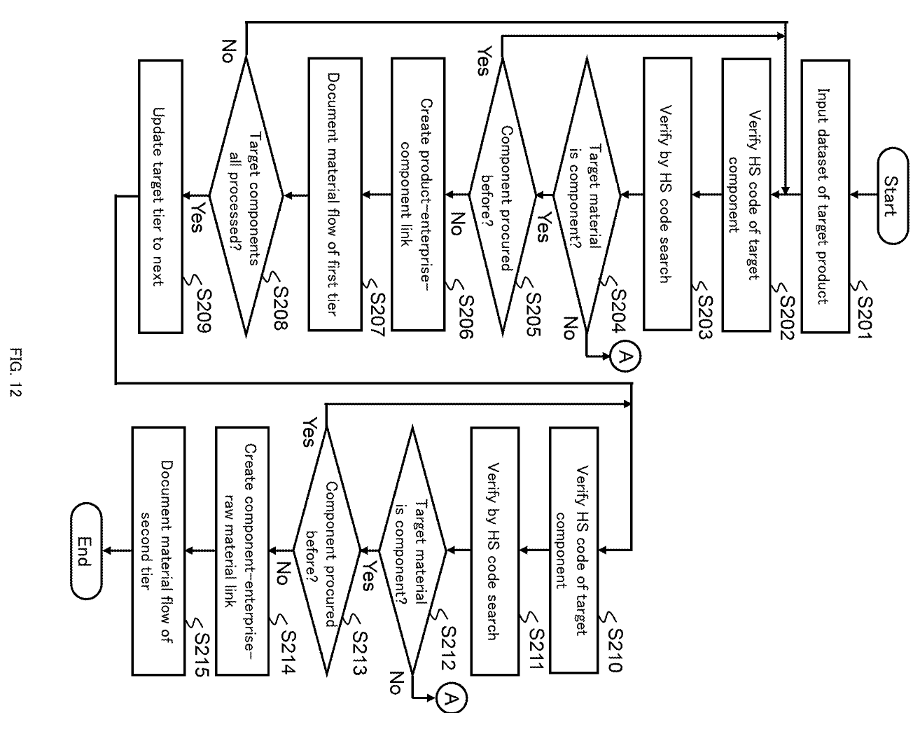

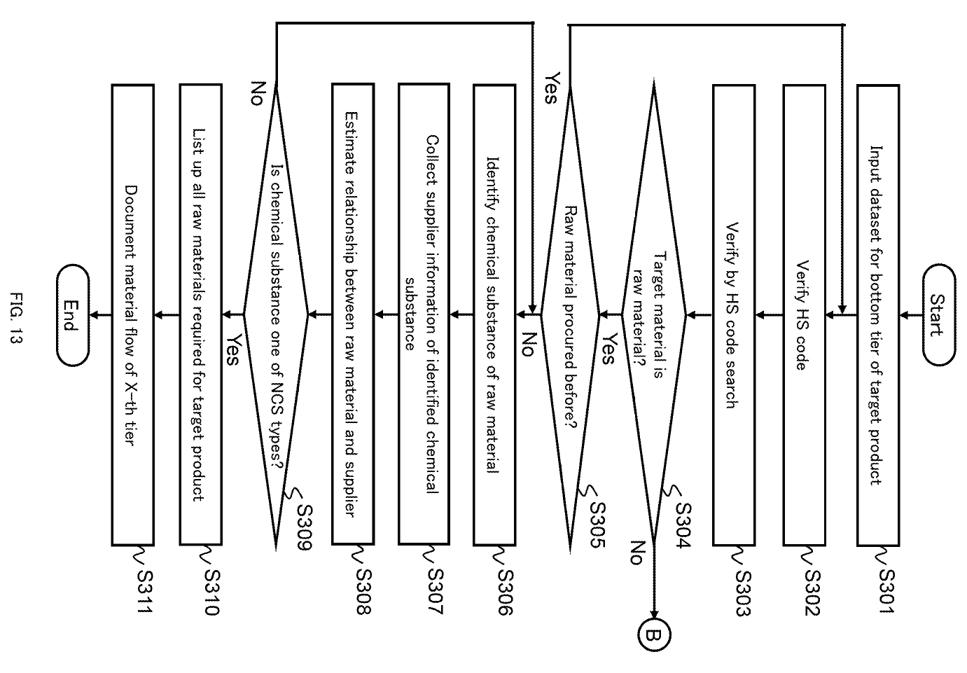

Next, a specific example of the processing at step S103 shown in FIG. 9 is described with reference to FIGS. 10 and 11. FIG. 10 is a flowchart showing a procedure of generating a positive link model at step S103 shown in FIG. 9

At step P111, the TTB generator 12 extracts from the BOL data the information of a product, an enterprise, and a component. At step P112, the TTB generator 12 selects existing links that identify the existing "component-enterprise" and "enterprise-product" relationships. At step P113, the TTB generator 12 generates hyperedges linking the products and components, to establish more "component-enterprise" and "enterprise-product" relationships. At step P114, the TTB generator 12 verifies the generated hyperedge links using a search engine and public information, such as corporate websites and news articles, as well as an LLM (Large Language Model). Search engines are provided from an external server (not shown) via the network 6. A browser for operating search engines is stored in the storage section 4.

For example, to verify the authenticity of a link, the TTB generator 12 enters the prompt "I want to check if Component XXX is actually used by YYY to produce their products," into an LLM, and acquires an output from the LLM as a response to the prompt. In doing so, the TTB generator 12 may also enter the target product real data 23 into the LLM as teaching data. Moreover, the TTB generator 12 enters "Component XXX" and "YYY’s product" into a search engine’s search window, and verifies the authenticity of the link that associate YYY’s product with Component XXX based on whether or not information indicating that "Component XXX is used in the production of YYY’s product" can be found.

At step P115, the TTB generator 12 extracts the information of the product description from a procurement record including the product maker’s BOL. At step P116, the TTB generator 12 verifies the HS code. Specifically, the TTB generator 12 performs manual or similarity checks using the HS code and the public information to verify the HS code. At step P117, the TTB generator 12 generates a positive hyperedge link. Specifically, the TTB generator 12 generates a positive hyperedge link that represents a "component -> enterprise -> product" relationship when keywords found in the product description match the HS code in the public information.

A positive link model that correctly links materials is thus created. The link may be generated across plural tiers. The procedure shown in FIG. 10 is designed to generate a more accurate BOM by mapping complex relationships in the supply chain, using data extraction and machine learning verification, as well as manual checks.

FIG. 11 is a flowchart showing a procedure of generating a negative link model at step S103 shown in FIG. 9. At step N111, the TTB generator 12 extracts from the BOL data the information of a product, an enterprise, and a component. At step N112, the TTB generator 12 generates a "component-enterprise-product" link for a component that is not used to produce the product. At step N113, the TTB generator 12 generates a negative link. For example, the TTB generator 12 creates a first-tier negative link with an irrelevant HS code, using a generative AI (Artificial Intelligence).

At step N114, the TTB generator 12 verifies the generated negative link. For example, the TTB generator 12 verifies that the "component-enterprise-product" link connecting these nodes is incorrect, i.e., a negative link, using an LLM, search engines, and public information such as corporate websites and news articles. At step N115, the TTB generator 12 identifies the description of the component’s HS code that was acquired in the verification process. The TTB generator 12 then deletes an HS code that may potentially be linked to the product’s HS code from the negative link. At step N116, the TTB generator 12 performs manual or similarity checks using external public information to verify the HS code. At step N117, the TTB generator 12 generates a negative hyperedge link that maps the "component -> enterprise -> product" relationship for the component that is not used in the product.

A negative link model that indicates incorrect links between materials is thus created. The link may be generated across plural tiers. The procedure shown in FIG. 11 serves to identify and map relationships for components that are not used, thereby improving the transparency and accuracy of the supply chain. The positive and negative link models enhance the accuracy of generated links that associate components with the product.

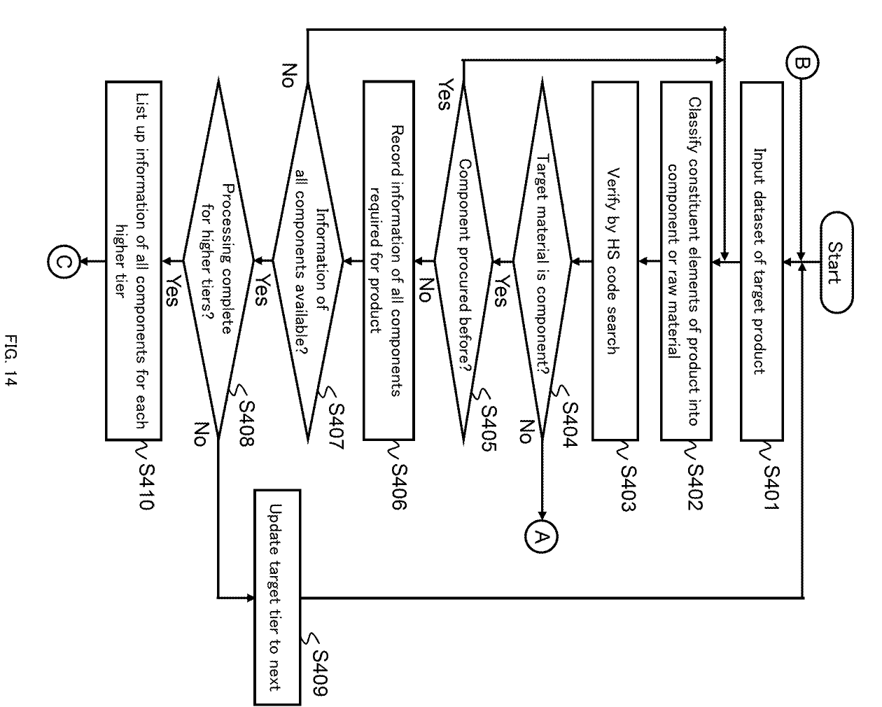

Next, a specific example of the processing at step S104 shown in FIG. 9 is described with reference to FIG. 12. FIG. 12 is a flowchart showing the procedure of a specific example of processing at step S104 shown in FIG. 9. The flowchart of FIG. 12 shows the process of generating a TTB of a target product.

At step S201, a dataset of a target product including information of suppliers, buyers, and makers is input to the TTB generator 12. For example, the dataset includes: the information of the product’s suppliers and buyers, as well as the component makers and product makers extracted from the BOL data; and the information of positive and negative link models. The target product belongs to the first tier. In the example described here, the top tier includes a first tier and a second tier. The second tier is lower than the first tier.

The TTB generator 12 estimates a TTB of the target product through processing from steps S202 to S208. At step S202, the TTB generator 12 verifies the HS code of a target component. For example, the TTB generator 12 divides the target product into one or more components, and verifies the accuracy of the HS code of the target component using an LLM. Specifically, the TTB generator 12 enters the prompt "I want to check if the component with an HS code XXXXX is actually used by YYY to produce their product," into an LLM. In doing so, the TTB generator 12 may also enter the target product real data 23 into the LLM as teaching data. The TTB generator 12 acquires an output from the LLM as a response to the prompt. The TTB generator 12 verifies the authenticity of the HS code based on the output from the LLM.

At step S203, the TTB generator 12 verifies the HS code by HS code search with reference to the product description field in the BOL data. Specifically, the TTB generator 12 extracts a keyword from the product description with respect to the component corresponding to the HS code. The TTB generator 12 enters the HS code and the keyword extracted from the product description in a search engine’s search window, and receives the search results from the search engine. The TTB generator 12 determines whether or not the component shown in the search results matches the component corresponding to the HS code entered into the search window. This determination allows the TTB generator 12 to verify the authenticity of the HS code, i.e., whether the HS code represents the target component. Such verification of whether an HS code matches a material improves the accuracy of links between materials, such as the links that associate components with the product, and links that associate raw materials with a component. At step S204, the TTB generator 12 determines whether or not a target material is a component.

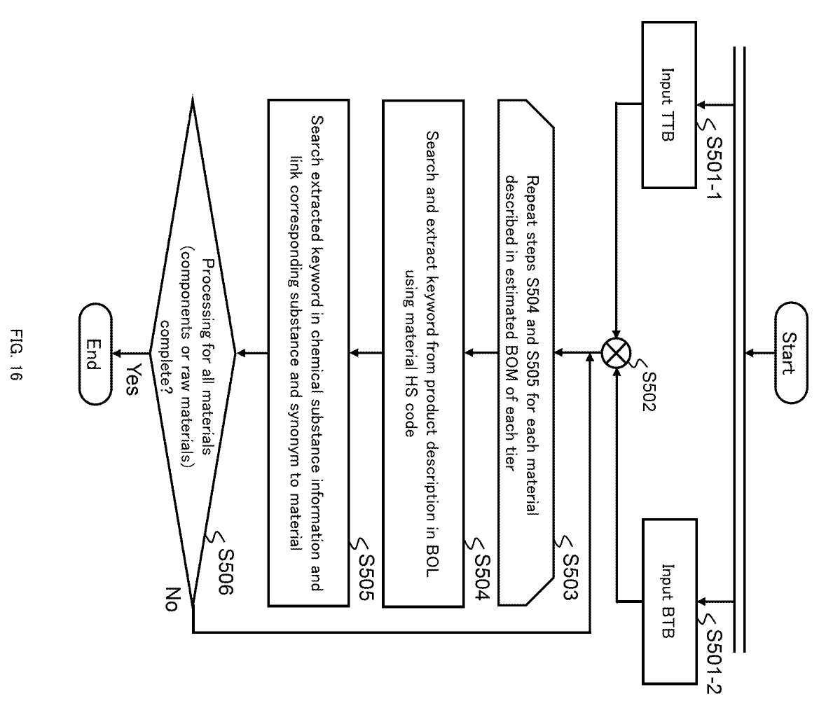

If the result of determination at step S204 indicates that the target material is a component, the TTB generator 12 proceeds to step S205. If the result of determination at step S204 indicates that the target material is not a component, the TTB generator 12 proceeds to the lower-tier flow shown in FIG. 15. At step S205, the TTB generator 12 determines whether or not the target component is a component that has been procured before. If the target material is a component that has never been procured, the TTB generator 12 proceeds to step S206. If the target component is a component that has been procured before, the TTB generator 12 returns to step S202. This is because components that have been procured in the past are already registered in the BOL data so that there is no need to estimate a BOM.

At step S206, the TTB generator 12 assigns a name to an enterprise’s component, and maps the target product to an enterprise name and the component name. The TTB generator 12 performs this step with reference to the positive and negative link models. At step S207, the TTB generator 12 documents the material flow of the first tier, which associates the target product with the components related to this product. The documented information of the first-tier material flow corresponds to the estimated BOM. The estimated BOM is, for example, the TTB data previously described with reference to FIG. 5. While the "description" field is omitted in FIG. 5, the table maps various items to each other, such as "product-enterprise-component-description." At step S208, the TTB generator 12 determines whether or not the processing has been complete for all the components associated with the target product. If the components associated with the target product have not all been processed, the TTB generator 12 returns to step S202. If the components associated with the target product have all been processed, the TTB generator 12 proceeds to step S209.

At step S209, the TTB generator 12 updates the processing target tier to the second tier. The TTB generator 12 estimates a BOM of the components belonging to the second tier through processing from steps S210 to S215. At step S210, the TTB generator 12 reads the HS codes of the components that constitute the product from the BOM of the first tier, and verifies the HS code of a target component. The TTB generator 12 uses an LLM, for example, for the verification. In doing so, the TTB generator 12 may also enter the target product real data 23 into the LLM as teaching data. At step S211, the TTB generator 12 verifies the HS code by HS code search using the component description estimated in the first tier. The TTB generator 12 uses a search engine, for example, for the verification. At step S212, the TTB generator 12 determines whether or not a target material is a component, similarly to the processing in the first tier.

If the result of determination at step S212 indicates that the target material is a component, the TTB generator 12 proceeds to step S213. If the result of determination at step S212 indicates that the target material is not a component, the TTB generator 12 proceeds to the lower-tier flow shown in FIG. 15. At step S213, the TTB generator 12 determines whether or not the target component is a component that has been procured before. If the target material is a component that has never been procured, the TTB generator 12 proceeds to step S214. If the target material is a component that has been procured before, the TTB generator 12 returns to step S210.

At step S214, the TTB generator 12 identifies the component, and maps the component to an enterprise and a raw material. At step S215, the TTB generator 12 documents the second-tier material flow, which describes the details of components, subcomponents, and raw materials. The estimated BOM looks similar to the data previously described with reference to FIG. 5. The documented information of the second-tier material flow is the information mapping various items to each other, such as "component name-enterprise-subcomponent" and "subcomponent-enterprise-raw material."

The flowchart shown in FIG. 12 provides a structured approach for generating BOMs of both components and raw materials. HS codes and machine learning model are used for the classification and verification. This enables the tracking of all the constituent elements and materials through the tiers and improves the transparency and efficiency of the supply chain. While the component belonging to the second tier is composed of one or more raw materials in the example described above with reference to FIG. 12, the component may instead be a subcomponent belonging to a tier lower than the second tier and higher than the bottom tier.

Next, a specific example of the processing at step S108 shown in FIG. 9 is described with reference to FIG. 13. FIG. 13 is a flowchart showing the procedure of a specific example of processing at step S108 shown in FIG. 9. The flowchart of FIG. 13 shows the process of generating a BTB of a target product. The processing target of the flow shown in FIG. 13 is a raw material. The flow shown in FIG. 13 shall be referred to as the lower-tier flow. The bottom tier, which is the processing target of the flow shown in FIG. 13, shall be referred to as the X-th tier. X is an integer of 2 or more. The BTB generator 14 changes the value of X according to the number of tiers that constitute the supply chain of a target product.

At step S301, a dataset relating to the bottom tier of a target product, is input to the BTB generator 14. The dataset is, for example, the BOM data of a higher tier adjacent the bottom tier, and public information 32. The BTB generator 14 identifies raw materials required for the production of a component, and estimates a BOM of the bottom tier through processing from steps S302 to S311. At step S302, the BTB generator 14 verifies the HS codes of the raw materials of one or more components that configure the target product, using a machine learning model. The machine learning model is, for example, an LLM. In doing so, the BTB generator 14 may also enter the target product real data 23 into the LLM as teaching data. At step S303, the BTB generator 14 verifies the HS codes by HS code search, using the product description in the BOL data and a search engine, to ensure the accuracy of the raw material HS codes. At step S304, the BTB generator 14 determines whether or not a target material is a raw material.

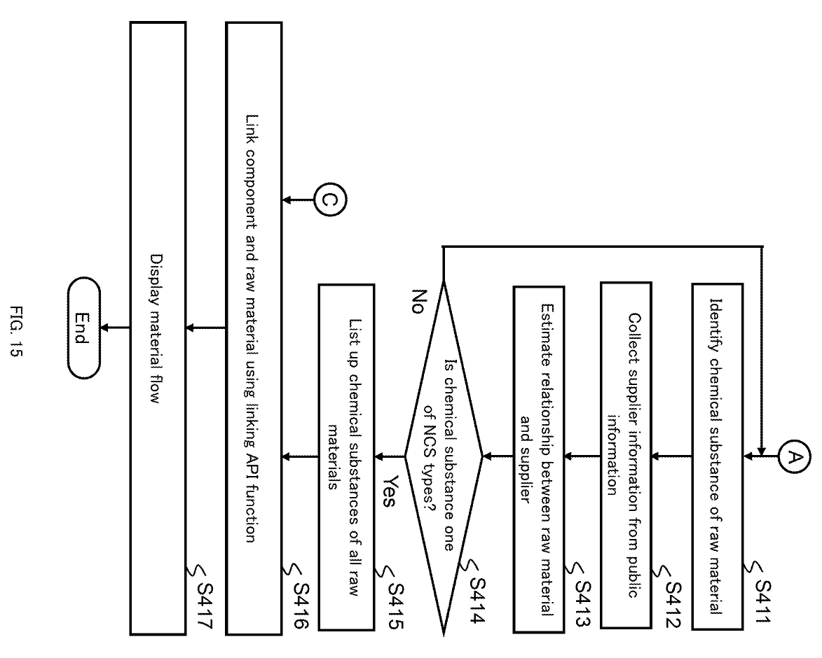

If the result of determination at step S304 indicates that the target material is not a raw material, the BTB generator 14 proceeds to the higher-tier flow shown in FIG. 14. If the result of determination at step S304 indicates that the target material is a raw material, the BTB generator 14 proceeds to step S305. At step S305, the BTB generator 14 determines whether or not the target raw material is a raw material that has been procured before. If the target raw material is a raw material that has never been procured, the BTB generator 14 proceeds to step S306. If the target raw material is a raw material that has been procured before, the BTB generator 14 returns to step S302.

At step S306, the BTB generator 14 focuses on chemical substance names; it breaks down every raw material required for the target component into chemical substances, and identifies them. At step S307, the BTB generator 14 collects information of the suppliers of the identified chemical substances by referring to public information. The public information is, for example, news releases, media reports, company reports, history data, or ChemSHERPA (registered trademark). The history data is, for example, BOL data. The BTB generator 14 lists up all raw materials required for the target component and the suppliers of the chemical substances contained in the raw materials. At step S308, the BTB generator 14 estimates a relationship between the raw materials and the suppliers by applying a machine learning algorithm to the list. The machine learning algorithm is, for example, AdaBoost (Adaptive Boosting).

At step S309, the BTB generator 14 determines whether a chemical substance constituting a raw material is classified into one of the NCS categories. If there is a chemical substance that is classified into none of the NCS categories, the BTB generator 14 returns to step S306 to further break it down into substances that can be classified into one of the NCS categories. When all the chemical substances constituting the raw material are classified into one of the NCS categories, the BTB generator 14 proceeds to step S310.

At step S310, the BTB generator 14 creates a comprehensive list of all the raw materials required to produce the target product, including the enterprises that supply the raw materials and descriptions of each raw material. At step S311, the BTB generator 14 documents the material flow of the X-th tier. The documented material flow of the X-th tier provides the information corresponding to the estimated BOM. The estimated BOM is, for example, the BTB data previously described with reference to FIG. 6. The documented material flow of the X-th tier shows information mapping the items to each other, such as "enterprise-evaluation value-raw material-raw material description."

The flowchart shown in FIG. 13 provides the users with a method of correctly identifying and tracking a continuous flow of raw materials that are the source of the supply chain. The BTB generator 14 uses HS codes, machine learning models, and public information to establish comprehensive relationships between raw materials and chemical substances and helps users to understand them. The list allows the users to identify suppliers of a raw material, enabling them to purchase from new suppliers, even during a logistics stagnation with their usual supplier.

Next, a specific example of the processing at steps S104 to S108 shown in FIG. 9 is described with reference to FIGS. 14 and 15. FIGS. 14 and 15 are flowcharts showing the procedures of specific examples of the processing at steps S104 to S108 shown in FIG. 9.

Steps S401 to S410 in FIG. 14 show the processing procedure for obtaining a BOM of the higher-tier flow of the entire supply chain. Steps S401 to S410 are the processing procedure mainly targeting the components that are the constituent elements of a product. Steps S401 to S410 in FIG. 14 are a simplified version of the flowchart shown in FIG. 12.

At step S401, a dataset including important information, such as supplier names, buyer names, component names, volume, HS codes, prices, and dates, about a target product, is entered into the TTB generator 12. The TTB generator 12 carries out steps S402 to S410 to estimate a TTB including information of the HS codes corresponding to all the components required for the product, and a BOM including information of the HS codes corresponding to subcomponents or raw materials required for each of the components.

At step S402, the TTB generator 12 applies transfer learning to a common LLM to classify all the constituent elements of the product into components or raw materials. At step S403, the TTB generator 12 verifies all the classification results of step S402 by HS code search. At step S404, the TTB generator 12 determines whether or not each classified target is a component. If the result of determination at step S404 indicates that the target is a raw material, the TTB generator 12 proceeds to step S411 shown in FIG. 15. If the result of determination at step S404 indicates that the target is a component, the TTB generator 12 proceeds to step S405.

At step S405, the TTB generator 12 determines whether or not the target component is a component that has been procured. If the target material is a component that has never been procured, the TTB generator 12 proceeds to step S406. If the target material is a component that has been procured before, the TTB generator 12 returns to step S402. At step S406, the TTB generator 12 identifies an "enterprise name-component name" pair for all the components required for the product, and records the enterprise name, component name, and HS code for each component. At step S407, the TTB generator 12 determines whether or not there is a record of information of all the components required for the product.

If the result of determination at step S407 indicates that information of all the components required for the product has not been recorded, the TTB generator 12 returns to step S402. If the result of determination at step S407 indicates that information of all the components required for the product has been recorded, the TTB generator 12 proceeds to step S408. At step S408, the TTB generator 12 determines whether or not the processing has been completed for all the higher tiers.

If the result of determination at step S408 indicates that the processing has not been completed for all the higher tiers, the TTB generator 12 proceeds to step S409. At step S409, the TTB generator 12 updates the target tier to the next one. For example, once the processing is complete for the first tier, the TTB generator 12 updates the target tier to the second tier. After step S409, the TTB generator 12 returns to step S401.

If the result of determination at step S408 indicates that the processing has been completed for all the higher tiers, the TTB generator 12 proceeds to step S410. At step S410, the TTB generator 12 lists up the information of all the components for each of the higher tiers. The list of the information of all the components for each tier corresponds to the BOM data. The TTB generator 12 outputs the BOM data of each of the higher tiers to the link generator 13.

There may be one higher tier, or two or more. For example, if there is one higher tier, the TTB generator 12 outputs only the TTB data as the BOM data to the link generator 13. If there are two higher tiers, the BOM data to be output to the link generator 13 from the TTB generator 12 is the TTB data and the BOM data of the second tier.

Steps S411 to S415 in FIG. 15 show the processing procedure for obtaining a BOM of the lower-tier flow of the entire supply chain. Steps S411 to S415 are the processing procedure for mainly the raw materials that are the constituent elements of a component. Steps S411 to S415 in FIG. 15 are a simplified version of the flowchart shown in FIG. 13.

At step S411 shown in FIG. 15, the BTB generator 14 identifies a chemical substance of a target raw material. At step S412, the BTB generator 14 collects information on the suppliers of the raw material from public information. The public information is, for example, news releases, media reports, company reports, history data, local news, or chemical substance information 33. At step S413, the BTB generator 14 estimates a relationship between the raw material and suppliers extracted from the public information. For example, the BTB generator 14 estimates a relationship between the raw material and a supplier based on a machine learning algorithm that uses AdaBoost. At step S414, the BTB generator 14 determines whether or not a chemical substance of the target raw material is classified into one of the NCS categories.

If the determination result at step S414 indicates that the chemical substance is classified into none of the NCS categories, the BTB generator 14 returns to step S411 to further break it down into substances that can be classified into one of the NCS categories. If the chemical substance is classified into one of the NCS categories, the BTB generator 14 proceeds to step S415. At step S415, the BTB generator 14 creates a list specifying the information about the chemical substances and suppliers for each of all the raw materials making up the product. The created list corresponds to the BTB data. Thus BOM data that provides comprehensive information of the raw materials of all the components required for the production of the product. The BTB generator 14 outputs the BTB data to the link generator 13.

At step S416, the link generator 13 creates links using the function of the linking API in the BOM data of various tiers input from the TTB generator 12 and BTB generator 14 to manage dependencies and relevancies between components and raw materials. The link generator 13 recognizes the components and the raw materials as nodes, using the chemical substance information 33, such as to cover the material flow including the product, components, and subcomponents. At step S417, the link generator 13 creates a material flow showing a continuous flow from the product in the top tier to a raw material in the bottom tier, and displays the generated material flow on the display apparatus 46. Thus a visual representation of the entire supply chain is provided to the users.

The procedures described with reference to FIGS. 14 and 15 show the overview of the entire process, from data processing to displaying an overall material flow. The procedures shown in FIGS. 14 and 15 integrate higher-tier and lower-tier flows and guarantee comprehensive tracking and visualization of a material flow within the production context of a target product. The machine learning model used for the estimation of BOMs in the flows described with reference to FIGS. 9 to 15 may be a graph neural network (GNN).

The information processing system 1 uses an LLM or a machine learning model such as a GNN to estimate the component table for each tier, generate links between materials for each pair of higher and lower tiers, and to visualize the overall flow in the supply chain. This allows the users to understand the flow in detail from the top to bottom tiers of the supply chain.

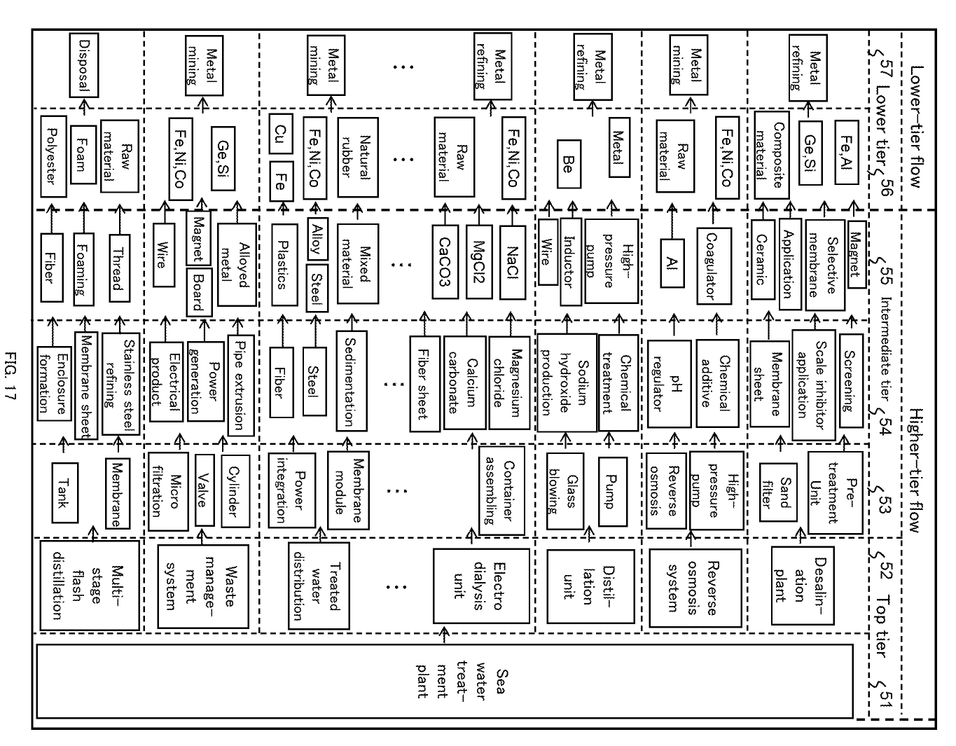

Next, a specific example of the processing at step S106 shown in FIG. 9 and step S416 shown in FIG. 15 is described with reference to FIG. 16. FIG. 16 is a flowchart showing the procedure of a specific example of processing at step S106 shown in FIG. 9 and step S416 shown in FIG. 15.

At step S501-1, TTB data is input from the TTB generator 12 to the link generator 13. At step S501-2, BTB data is input from the BTB generator 14 to the link generator 13. While TTB data and BTB data are input to the link generator 13 in the example shown in FIG. 16, the TTB generator 12 and/or the BTB generator 14 may output estimation results of BOM for several tiers to the link generator 13. For example, the TTB generator 12 outputs the estimation results of BOM for the first tier and second tier that were described with reference to FIG. 12 to the link generator 13.

At step S502, the link generator 13 integrates the estimated BOM of each tier received from each of the TTB generator 12 and the BTB generator 14. At step S503, the link generator 13 repeats the linking process of steps S504 and S505 for each material that is either a component or a raw material described in the estimated BOM of each tier. All materials are analyzed individually by this repeated process, allowing for accurate linking of materials with one another.

At step S504, the link generator 13 conducts a search along the row of the product description field within the BOL, using an HS code corresponding to a material that is either a component or a raw material. The link generator 13 extracts keywords from the product descriptions, using material HS codes as search keys. This keyword extraction is an important step to link a material with its use. For example, keywords such as "ceramic membrane" or "glass fiber" are extracted from product descriptions.

At step S505, the link generator 13 searches the extracted keyword in the chemical substance information 33, which is a database including detailed information relating to the uses of chemical substances. Referring to the table shown in FIG. 4, the typical usage field specifies typical uses such as "ceramic" and "additive." The link generator 13 reads from the chemical substance information 33 a specified substance and its synonym corresponding to the use that matches the keyword, and links the specified substance and its synonym with a target material that is either a component or a raw material. While the keyword here is the "use" of a material in this example, the keyword is not limited to the "use." For example, "specification" of a material may be used as the keyword.

At step S506, the link generator 13 determines whether or not the linking process of steps S504 and S505 has been completed for the components and all materials of raw material in each tier. If there are components or raw materials that have not been linked yet, the link generator returns to step S503. When the linking process is completed for the components and all materials of raw material, the link generator 13 ends the linking process. Thus the linking across tiers of the material flow is complete. The inter-tier links are integrated by thus combining the BOM data of each tier from top to bottom, enabling comprehensive tracking and visualization of material flow.

The materials of higher and lower tiers are linked by the functions of the linking API for each pair of adjacent higher and lower tiers based on chemical substance information such as ChemSHERPA (registered trademark) data and product descriptions in the bills of materials. Specifically, nodes are linked such as "product -> component -> subcomponent -> raw material." Namely, a raw material in the bottom tier is linked to a subcomponent of the intermediate tier. The subcomponent is linked to a component in the intermediate tier. The component of the intermediate tier is linked to a product of the top tier. In this way, an overall material flow of the supply chain is created in a comprehensive manner.

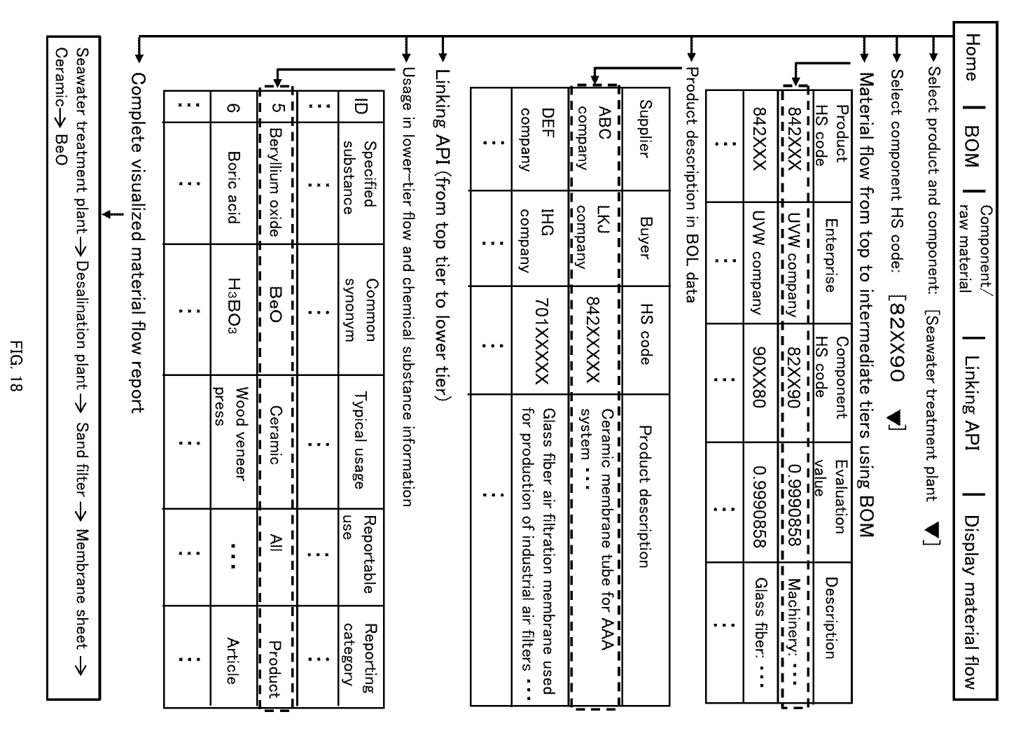

FIG. 17 is a diagram illustrating an example of a material flow generated by the information processing system according to the embodiment. FIG. 17 shows a material flow when the target product is a seawater treatment plant. When the user selects the seawater treatment plant as the target product, the material flow shown in FIG. 17 is displayed on the display apparatus 46. The material flow shown in FIG. 17 indicates the transfer from a supplier in the bottom tier to a supplier in the top tier via a supplier in the intermediate tier regarding the seawater treatment plant. FIG. 17 shows the names of components, subcomponents, and raw materials. The supplier names are omitted.

For example, at step S417 shown in FIG. 15, the display apparatus 46 displays the material flow shown in FIG. 17. As shown in FIG. 17, the material flow is made up of a higher-tier flow and a lower-tier flow. The higher-tier flow is made up of the top tier and the intermediate tier. The top tier includes a product tier 51 and a component tier 52. The intermediate tier includes a component tier 53 and subcomponent tiers 54 and 55. The lower-tier flow includes a raw material tier 56 and a treatment tier 57. The intermediate tier field may further display the content of treatment performed to the subcomponents in addition to the subcomponent names.

The product tier 51 field displays seawater treatment plant as the product selected by the user. The component tier 52 field displays a plurality of units that form the seawater treatment plant. Specifically, the component tier 52 field displays desalination plant, reverse osmosis system, distillation unit, electrodialysis unit, treated water distribution, waste management system, and multi-stage flash distillation.

The component tier 53 field displays one or more components that form a component belonging to the component tier 52. Specifically, when the component of the component tier 52 is a desalination plant, the component tier 53 field displays pre-treatment unit and sand filter. The subcomponent tier 54 field displays one or more subcomponents that form a component belonging to the component tier 53. Specifically, when the components of the component tier 53 are pre-treatment unit and sand filter, the subcomponent tier 54 field displays screening, scale inhibitor application, and membrane sheet. The subcomponent tier 55 field displays one or more subcomponents that form a subcomponent belonging to the subcomponent tier 54. Specifically, when the subcomponents of the subcomponent tier 54 are screening, scale inhibitor application, and membrane sheet, the subcomponent tier 55 field displays magnet, selective membrane, application, and ceramic.

The raw material tier 56 field displays one or more raw materials that form a subcomponent belonging to the subcomponent tier 55. Specifically, when the subcomponent in the subcomponent tier 55 is ceramic, the raw material tier 56 field displays composite material. The treatment tier 57 field displays necessary treatment before a raw material in the raw material tier 56 is provided to a subcomponent supplier. Specifically, when the raw material in the raw material tier 56 is Fe (iron) and Al (aluminum), the treatment tier 57 field displays metal refining. The raw material refined in the treatment tier 57 proceeds to the raw material tier 56 to be ready for use in the production by a supplier in the next intermediate tier. In the lower-tier flow, chemical substances are converted into raw materials required for an advanced production process in the intermediate and top tiers. Therefore, the lower-tier flow represents the basic stage of the supply chain.

In the material flow, the higher-tier flow and the lower-tier flow respectively represent a path that connects materials from the final product to raw materials, and the conversion of materials from the raw materials to the product via subcomponents and components. Referring to FIG. 17, the product is shown on the right side. The components that make up the product, subcomponents, and raw materials are shown in this order from the product from right to left. While the supply chain is divided into units, such as the desalination plant, by horizontal broken lines in FIG. 17, there may be a path that connects materials vertically across the broken lines. An example of such a vertical path will be described later.

FIG. 17 effectively shows the logical flow of materials such as components and raw materials spanning multiple tiers of the supply chain of a seawater treatment plant. As shown in FIG. 17, the material flow integrates a lower-tier flow that represents treatment such as extraction and refining of raw materials, and a higher-tier flow that represents the target product and the components making up the target product. This integration visualizes the details of materials, enhancing the supply chain transparency and improving the tracking efficiency. The clear mapping of each stage from raw material procurement to the product optimizes the material flow and ensures the sustainability of the seawater treatment plant.

The material flow shows the transitions from raw materials to the final product through various tiers of subcomponents and components. The material flow presented to users allows them to track materials along a path from the initial procurement of raw materials to the final stage of production. This gives them a complete understanding of the supply chain’s material dependencies. The material flow enables the users to track materials stepwise from the bottom tier to the top tier.

For the convenience of explanation, the plural units such as the desalination plant are classified into the component tier 52. However, these units may be classified into the product tier. This is because these units such as the desalination plant could become the final product of the supply chain for the suppliers of these units. The tier to which the subcomponents belong is referred to as the intermediate tier here. However, subcomponents may belong to tiers other than the intermediate tier. Some of the subcomponents may belong to a higher tier, and the others may belong to a lower tier. For the convenience of explanation, the components that belong to the intermediate tier are referred to as subcomponents here. However, subcomponents are also a type of components.

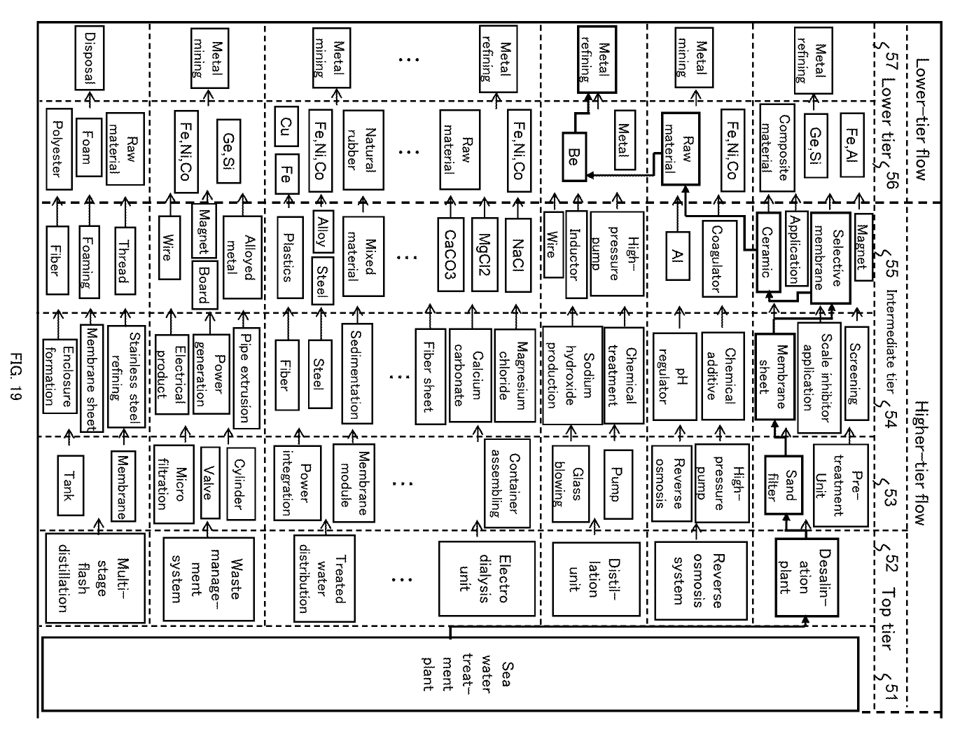

Next, an example of a display method is described, in which a user displays the supply chain of a target product on the display apparatus 46 using a GUI (Graphical User Interface) of the information processing system 1. FIG. 18 is a diagram illustrating an example of GUI provided for users by the information processing system according to the embodiment.

As illustrated in FIG. 18, the display apparatus 46 displays multiple steps to indicate navigation to the user. The multiple steps include "Home," "BOM," "Component/Raw material," "Linking API," and "Display material flow." The information processing system 1 sequentially proceeds from the "Home" step to the "Display material flow" step. The GUI provides the user with a comprehensive tool to manage the material flow, by integrating the BOM, BOL, and chemical substance information to make the material flow visible.

A user selects a target product in the "Product and component selection" section of the "Home" step. FIG. 18 shows a case in which the user has selected "Seawater treatment plant" from multiple types of products, and has selected "Desalination plant" from multiple types of components. "Seawater treatment plant" is an example of multiple types of products that belong to the product tier 51 shown in FIG. 17. "Desalination plant" is an example of multiple types of components that belong to the component tier 52 shown in FIG. 17.

The user selects a component from multiple types in the "Component HS code selection" section of the "Home" step. For example, the user selects a specific HS code, such as "82XX90." "82XX90" is the HS code of one of the multiple types of components that belong to the component tier 53 shown in FIG. 17. The link generator 13 determines whether or not the material corresponding to the HS code selected by the user is a component or a raw material. The link generator 13 extracts components related to the product selected by the user, using the HS code as the key.

In the "Material flow from top to intermediate tiers using BOM" section of the "BOM" step, the link generator 13 displays a BOM table, which includes the product HS code, enterprise, component HS code, evaluation value, and description rows, on the display apparatus 46. For example, the BOM indicates that the component with the component HS code "82XX90" made by "UVW company" is rated at a high score of "0.9990858," and described as "Machinery: Component for filtration or clarification of liquid or gas."

In the "Product description in BOL data" section of the "Component/Raw material" step, the link generator 13 displays the BOL data below the BOM table on the display apparatus 46. The BOL data includes the transaction data of suppliers and buyers, HS codes, and detailed product descriptions. For example, the BOL data provides the user with the information that ABC company is a supplier of the ceramic membrane tube with the HS code 82XX90, as well as a detailed specification of the ceramic membrane tube.

In the "Linking API" step, the link generator 13 links materials of adjacent higher and lower tiers from the top tier to the bottom tier, using the function of the linking API. The link generator 13 provides the user with easy and seamless navigation through materials of adjacent higher and lower tiers of the material flow. This linking of materials based on the chemical substance information gives the user an understanding of the relationships and dependencies between the materials.

In the "Usage in lower-tier flow and chemical substance information" section, the link generator 13 identifies a chemical substance that makes up a raw material in the lower-tier flow, with reference to the usage information in the chemical substance information. FIG. 18 shows the items such as specified substance, common synonym, typical usage, reportable use, and reporting category, as part of the chemical substance information. For example, when the specified substance is beryllium oxide, the chemical substance

information shows "BeO" as a synonym, and "ceramic" as a typical usage. The chemical substance information may also include the use methods of raw materials and regulatory considerations.

In the "Complete visualized material flow report" section of the "Display material flow" step, the link generator 13 displays a material flow showing a continuous flow from the seawater treatment plant to beryllium oxide on the display apparatus 46. Namely, the link generator 13 displays a material flow such as "Seawater treatment plant -> Desalination plant -> Sand filter -> Membrane sheet -> Ceramic -> BeO" on the display apparatus 46. Thus a report that makes the material flow visible is created, which shows inter-tier links, such as "Product -> Component -> Subcomponent -> ... -> Raw material." This report provides the user with the necessary information on inventory dependencies. Making the comprehensive material flow visible allows the user to understand the continuous flow of conversion from a raw material to a product that is required in the production cycle of the product. Visualizing the material flow improves the reliability of the supply chain.

FIG. 19 is a diagram illustrating an example of a visualized material flow provided for users by the information processing system according to the embodiment. The display apparatus 46 displays the material flow shown in FIG. 19. FIG. 19 highlights the flow of materials from the "Sea water treatment plant" in the top tier to the raw material "Be" in the bottom tier in the material flow shown in FIG. 17, tracked according to the procedure described with reference to FIG. 18.

Referring to FIG. 19, "Seawater treatment plant," "Desalination plant," "Sand filter," "Membrane sheet," "Selective membrane," "Ceramic," "Raw material," "Be," and "Metal refining" are framed with bold lines. Although not shown in FIG. 19, the display apparatus 46 may display not only the materials but also the suppliers of the materials in respective tiers from top to bottom tiers with respect to the seawater treatment plant. The display apparatus 46 may also highlight key components such as reverse osmosis membrane, chemical additive, and distillation unit.

Let us now look at the highlighted components in the higher-tier flow. The "Desalination plant" where seawater is treated first is highlighted in the component tier 52, which is a lower tier of the product tier 51. The "Sand filter" that removes impurities from the seawater is highlighted in the component tier 53, which is a lower tier of the component tier 52. The "Membrane sheet" is highlighted in the subcomponent tier 54, which is a lower tier of the component tier 53. The "Selective membrane" and "Ceramic" are highlighted in the subcomponent tier 55, which is a lower tier of the component tier 54.

Let us now look at the highlighted raw materials in the lower-tier flow. The "Raw material" is highlighted in the raw material tier 56 of the lower-tier flow. The highlighted "Raw material" is the same as the raw material that is one of the constituent elements of the reverse osmosis system in the component tier 52. The "Ceramic," one of the constituent elements of the desalination plant, and "Raw material," one of the constituent elements of the reverse osmosis system, are linked by a bold arrow. This indicates that the raw material of the "Ceramic" can be procured from a constituent element of the reverse osmosis system and not necessarily of the desalination plant.

In the raw material tier 56, "Be" that is one of the constituent elements of the "Distillation unit" in the component tier 52 is highlighted. The "Raw material," one of the constituent elements of the reverse osmosis system, and "Be," one of the constituent elements of the distillation unit, are linked by a bold arrow. This indicates that "Be," one of the constituent elements of the distillation unit, can be procured as a constituent element of the ceramic instead of procuring the "Raw material" from the constituent elements of the reverse osmosis system. In the treatment tier 57 that is a lower tier of the raw material tier 56, the "Metal refining" is highlighted.

In this way, a complete material flow is generated for the product, so that the flow in the supply chain is visible end to end from the product to the raw materials. By referring to the material flow in FIG. 19, the user can realize that beryllium (Be), which is one of the constituent elements of the distillation unit, can be used as the raw material of the ceramic used in the sand filter. For example, when a supplier of the raw material that is a constituent element of the desalination plant suspends production due to a natural disaster or the like, the user can procure the raw material of the ceramic from the supplier of beryllium. The mutual complementation between these units and systems ensures the implementation of advanced technologies used in the top-tier product to provide the public with top-quality treated water.

The effects of the visualized material flow provided to the user will be further described in more specific terms. An enterprise produces the seawater treatment plant shown in FIG. 19 by combining plural components such as the desalination plant and the reverse osmosis system. The BOL data of the desalination plant shows the component names and HS codes of the "Pre-treatment unit" and "Sand filter" in the upper field of the component tier 53 sectioned by horizontal broken lines in FIG. 19. The BOL data of the desalination plant shows the component names and HS codes of the "Screening," "Scale inhibitor application," and "Membrane sheet" in the upper field of the subcomponent tier 54 sectioned by horizontal broken lines in FIG. 19. However, the BOL data of the desalination plant could lack detailed information about the materials belonging to the subcomponent tier 55 and the raw material tier 56 in the upper field sectioned by horizontal broken lines in FIG. 19, showing only some of the information such as HS codes. The BOL data may also lack detailed information of materials in the flow from the intermediate to lower tiers with respect to other units such as the reverse osmosis system. In such a case, the user can only see a series of materials from the product to raw materials for each unit in FIG. 19, even with reference to the BOL data of each unit such as the desalination plant. Therefore, it would be difficult for the user to realize that beryllium (Be), which is one of the constituent elements of the distillation unit, can be used as the material of the ceramic used in the desalination plant.

The information processing system 1 of this embodiment highlights a continuous path connecting the "Sand filter" that is one of the constituent elements of the "Desalination plant" to "Beryllium" as shown in FIG. 19. The display apparatus 46 can also display suppliers of each raw material. This way, as described above, the user can procure the raw material of the ceramic from the supplier of beryllium, during the time when the supplier producing the raw material that is one of the constituent elements of the desalination plant suspends the plant operation.

The material flow shown in FIG. 19 visualizes the detailed flow of materials of the sand filter in the desalination plant for the user. This enhances the supply chain transparency and improves the supply chain tracking efficiency for the user. The clear mapping of each stage from raw material procurement to the product optimizes the material flow and ensures the sustainability of the seawater treatment plant.

The information processing system 1 provides enterprises with a clear forecast of supply chain operations by visualizing the material flow as described above. This embodiment helps enterprises make decisions and allows users to respond quickly and effectively to various disruptions in logistics. The visualized material flow allows users to track a specific raw material, which significantly improves supply chain resilience. The information processing system 1 of this embodiment not only enhances the supply chain transparency but also reinforces the ability to withstand unforeseen challenges in the supply chain. The information processing system 1 provides enterprises with a clear and continuous flow of materials to help them maintain continuity and efficiency. The secure and accurate integration of data from top to bottom tiers by the information processing system 1 assists enterprises with inventory management and reduces the risk associated with supply chain disruptions.

The information processing system 1 of this embodiment is an information processing system that manages a supply chain, and includes a storage apparatus, a memory that stores a program; and a processor 41 that executes processing according to the program. The storage apparatus is, for example, the storage apparatus 5. The memory is, for example, the main memory 42. The storage apparatus 5 stores: a bill of lading including information of a different code for each material that is either a component or a raw material of a product, and a description of the product; and chemical substance information relating to chemical substances contained in the raw material. The processor 41 operates as follows by executing the program. The processor 41 classifies a material in each tier between the product belonging to a top tier to the raw material belonging to a bottom tier of the supply chain either as a component or a raw material, based on the code information. The processor 41 links a material belonging to a higher tier and a material belonging to a lower tier for each pair of adjacent higher and lower tiers based on the product description and the chemical substance information. The processor 41 displays a material flow that shows a continuous flow of materials from the product belonging to the top tier to the raw material belonging to the bottom tier.

According to this embodiment, the materials in adjacent higher and lower tiers are linked from the product in the top tier to the raw material in the bottom tier. Since a material flow showing a continuous flow from the product to the raw material is displayed, the supply chain is visualized. According to this embodiment, an enterprise’s procurement personnel can ensure the smooth operation of their products’ supply chain, even during crises such as a pandemic or natural disaster, or in the event of logistics stagnation due to a disruption such as an imbalance between supply and demand. The information processing system 1 of this embodiment can compensate for supply chain vulnerability.

The effects of supply chain visualization are described in more specific terms. Making the supply chain visible provides enterprises with its comprehensive information. The information allows enterprises to manage potential risk that may arise in the supply chain and maintain efficient component procurement. The improved transparency of the material flow thanks to better material data integration enables enterprises to anticipate, and respond to, possible disruptions more effectively. This approach enables enterprises to strengthen their global supply chain resilience and prepares them better against unanticipated disruptions. Consequently, enterprises can maintain supply chain continuity, even during times of disruption.

Manufacturers of components or raw materials tend to avoid disclosing detailed information about their products to enterprises with which they have no business relationship. The information processing system 1 of this embodiment collects data fragments and more securely and accurately connects them to visualize the material flow that integrates data across supply chain tiers. This allows enterprises to review the entire material flow, identify potential issues sooner, and optimize supply chain operations. This not only helps enterprises to make better decisions, but reduces supply chain vulnerabilities. Visualizing the supply chain is particularly useful for procurement personnel as it allows them to understand inventory dependencies and to identify potential vulnerabilities in the supply chain more easily. The information processing system 1 provides a secure, highly adaptable framework applicable to enterprises of various sizes.

The above-described embodiment is an example for illustrating the present invention and is not intended to limit the scope of the invention. The person skilled in the art can carry out the present invention in various other forms without departing from the scope of the present invention.

The above-described embodiment includes the following items. Note, however, the items included in the present embodiment are not limited to the those shown below.

### Item 1

An information processing system managing a supply chain, which represents a continuous flow from raw material procurement to product sales, the system including:

a storage apparatus configured to store a bill of lading including information of a different code for each material that is either a component or a raw material of a product, and a description of the product, and chemical substance information relating to chemical substances contained in the raw material;

a memory configured to store a program; and

a processor configured to execute processing according to the program,

the processor being configured to execute the program to:

classify either as a component or a raw material a material in each tier between the product belonging to a top tier to the raw material belonging to a bottom tier of the supply chain, based on the code information;

link a material belonging to a higher tier and a material belonging to a lower tier for each pair of adjacent higher and lower tiers, based on the product description and the chemical substance information; and

display a material flow that shows a continuous flow from the product belonging to the top tier to the raw material belonging to the bottom tier.

The materials in adjacent higher and lower tiers are linked from the product in the top tier to the raw material in the bottom tier. Since the material flow showing a continuous flow from the product to the raw material is displayed, the supply chain is visualized.

### Item 2

The information processing system according to Item 1,

wherein the storage apparatus is configured to store public information of an enterprise that supplies the component or the raw material, and

wherein the processor is configured to

read a code from the bill of lading and inputs the code into a machine learning model, and receives from the machine learning model a response indicating whether a material corresponding to the code is classified as a component or a raw material, and

create a higher-tier flow indicating the material flow from the top tier to an intermediate tier, based on the bill of lading, when the material is classified as the component, and creates a lower-tier flow indicating the material flow from the intermediate tier to the bottom tier, based on the chemical substance information and the public information, when the material is classified as the raw material.

The materials corresponding to recorded codes in the bill of lading are classified either as a component or a raw material, and a higher-tier flow and a lower-tier flow that form the material flow are created according to the classification results. This creates a continuous path of materials from the top-tier product to raw materials via various components in the material flow. This helps minimize the generation of an erroneous material flow in which a raw material that belongs to the bottom tier is placed between the top tier and the intermediate tier.

### Item 3

The information processing system according to Item 2,

wherein, the processor is configured to, when creating the lower-tier flow,

break down the raw material until any of a plurality of predetermined chemical substances is identified,

collect information of an enterprise that provides the identified chemical substance from the public information, and create as a component table of the bottom tier a list that associates the enterprise, the raw material, and a description of the raw material with each other.

The list allows procurement personnel to identify suppliers of a raw material, enabling them to purchase from other, new suppliers even during a logistics stagnation with their usual supplier.

### Item 4

The information processing system according to one of Items 1 to 3,

wherein the processor is configured to

enter, in a search engine’s search window, the code and a keyword extracted from the product description about a material corresponding to the code, and receives a search result from the search engine, and

verify code accuracy by determining whether or not a material indicated by the search result matches the material corresponding to the code.

Verifying whether the code matches the material improves the accuracy of links between materials, such as a link that associates the product with a component, and a link that associates a component with a raw material.

### Item 5

The information processing system according to one of Items 1 to 4,

wherein the processor is configured to

link a material in an intermediate tier lower than the top tier with a material in the bottom tier by using information of a specification or use of a chemical substance contained in the chemical substance information,

estimate a component table for each tier from the top tier to the bottom tier, and

generate the material flow by using the component table of each tier.

A material belonging to a higher tier and a material belonging to a lower tier are linked for each pair of adjacent higher and lower tiers based on chemical substance information and product descriptions in the bills of materials. This enables the generation of the material flow that links materials from the top to bottom tiers.

### Item 6

The information processing system according to one of Items 1 to 5,

wherein the storage apparatus is configured to store public information of an enterprise that supplies the component or the raw material, and

wherein the processor is configured to

estimate a component table of the material for each tier from the top tier to the bottom tier,

estimate the component table of the product in the top tier by using the bill of lading and a positive link model indicating a correct link between materials and a negative link model indicating an incorrect link between materials, and

estimate the component table of the raw material belonging to the bottom tier, based on the chemical substance information and the public information.

The component table is estimated for each tier from the top tier to the bottom tier. The component table of the top tier is estimated based on the bill of lading, and positive and negative links. This improves the estimation accuracy of material flow in higher tiers, so that the estimation accuracy of the entire material flow is improved.

### Item 7

The information processing system according to Item 6,

wherein the processor is configured to

generate the positive link model using a pre-generated link that specifies a relationship between the component and the enterprise, and a relationship between the enterprise and the product, and

generate the negative link model by creating a link associating a component that is not used to produce the product, with an enterprise and the product, and using the generated link.

The positive link model is generated using an existing link, and the negative link model is generated to associate components that are not used in the product with the product. The positive and negative link models enhance the accuracy of generated links that associate the product with components.

What is claimed is:

1. An information processing system managing a supply chain, which represents a continuous flow from raw material procurement to product sales, the system comprising:
a storage apparatus configured to store
a bill of lading including information of a different code for each material that is either a component or a raw material of a product, and a description of the product, and
chemical substance information relating to chemical substances contained in the raw material;
a memory configured to store a program; and
a processor configured to execute processing according to the program,
the processor being configured to execute the program to:
classify either as a component or a raw material a material in each tier from the product belonging to a top tier to a raw material belonging to a bottom tier of the supply chain, based on the code information;
link a material belonging to a higher tier and a material belonging to a lower tier for each pair of adjacent higher and lower tiers, based on the product description and the chemical substance information; and
display a material flow that shows a continuous flow from the product belonging to the top tier to the raw material belonging to the bottom tier.

2. The information processing system according to claim 1,
wherein the storage apparatus is configured to store public information of an enterprise that supplies the component or the raw material, and
wherein the processor is configured to
read a code from the bill of lading and inputs the code into a machine learning model, and receives from the machine learning model a response indicating whether a material corresponding to the code is classified as a component or a raw material, and
create a higher-tier flow indicating a material flow from the top tier to an intermediate tier, based on the bill of lading, when the material is classified as the component, and creates a lower-tier flow indicating a material flow from the intermediate tier to the bottom tier, based on the chemical substance information and the public information, when the material is classified as the raw material.

3. The information processing system according to claim 2,
wherein, the processor is configured to, when creating the lower-tier flow,
break down the raw material until any of a plurality of predetermined chemical substances is identified,
collects information of an enterprise that provides the identified chemical substance from the public information, and
creates as a component table of the bottom tier a list that associates the enterprise, the raw material, and a description of the raw material with each other.

4. The information processing system according to claim 1,
wherein the processor is configured to
enter, in a search engine’s search window, the code and a keyword extracted from the product description about a material corresponding to the code, and receives a search result from the search engine, and
verify code accuracy by determining whether or not a material indicated by the search result matches the material corresponding to the code.

5. The information processing system according to claim 1,
wherein the processor is configured to
link a material in an intermediate tier lower than the top tier with a material in the bottom tier by using information of a specification or use of the chemical substance contained in the chemical substance information,
estimate a component table for each tier from the top tier to the bottom tier, and
generate the material flow by using the component table of each tier.

6. The information processing system according to claim 1,
wherein the storage apparatus is configured to store public information of an enterprise that supplies the component or the raw material, and
wherein the processor is configured to
estimate a component table of the material for each tier from the top tier to the bottom tier,
estimate the component table of the product in the top tier by using the bill of lading and a positive link model indicating a correct link between materials and a negative link model indicating an incorrect link between materials, and
estimate the component table of the raw material belonging to the bottom tier, based on the chemical substance information and the public information.

7. The information processing system according to claim 6,
wherein the processor is configured to
generate the positive link model using a pre-generated link that specifies a relationship between the component and the enterprise, and a relationship between the enterprise and the product, and
generate the negative link model by creating a link associating a component that is not used to produce the product, with an enterprise and the product, and using the generated link.

8. An information processing method implemented by an information processing apparatus, the method comprising:
storing a bill of lading including information of a different code for each material that is either a component or a raw material of a product, and a description of the product, and chemical substance information relating to chemical substances contained in the raw material;
classifying either as a component or a raw material a material in each tier from the product belonging to a top tier to the raw material belonging to a bottom tier of the supply chain, based on the code information;
linking a material belonging to a higher tier and a material belonging to a lower tier for each pair of adjacent higher and lower tiers, based on the product description and the chemical substance information, and
displaying a material flow that shows a continuous flow from the product belonging to the top tier to the raw material belonging to the bottom tier.

9. A non-transitory computer readable medium storing a program for causing a computer to execute:
storing a bill of lading including information of a different code for each material that is either a component or a raw material of a product, and a description of the product, and chemical substance information relating to chemical substances contained in the raw material;
classifying either as a component or a raw material a material in each tier from the product belonging to a top tier to the raw material belonging to a bottom tier of the supply chain, based on the code information;
linking a material belonging to a higher tier and a material belonging to a lower tier for each pair of adjacent higher and lower tiers, based on the product description and the chemical substance information, and
displaying a material flow that shows a continuous flow from the product belonging to the top tier to the raw material belonging to the bottom tier.
